(19) United States
(12) Patent Application Publication
(10) Pub. No.: US 2025/0200671 A1
(43) Pub. Date: Jun. 19, 2025

(54) SYSTEM AND METHOD FOR IMPLEMENTING A GLOBAL WITHHOLDING TAX ENGINE

(71) Applicant: KPMG LLP, New York, NY (US)

(72) Inventors: Andrew McQuilkin, West Newbury, MA (US); Cyrus E. Daftary, Newton, MA (US); Drew Demotses, Boston, MA (US); Sarish Siddiqui, Boston, MA (US); Kelli Wooten, Alexandria, VA (US)

(21) Appl. No.: 18/985,329

(22) Filed: Dec. 18, 2024

Related U.S. Application Data
(60) Provisional application No. 63/611,555, filed on Dec. 18, 2023.

(51) Int. Cl. G06Q 40/12; G06Q 10/0635

(52) U.S. Cl. CPC G06Q 40/123; G06Q 10/0635

(57) ABSTRACT

An embodiment of the present invention is directed to an automated Global Withholding Tax Engine that leverages standardized withholding tax rules and requirements across various jurisdictions. The Global Withholding Tax Engine addresses a need for tax automation in the global marketplace. The Global Withholding Tax Engine may be developed as a standalone engine that is system agnostic. It may offer standard APIs that receive as input data elements relevant to determine an applicable withholding rate. Because it utilizes a standard API, the engine may be connected to any system, whether it is an ERP or other payment system. This approach allows the flexibility to meet the needs of any client, and further expand the engine to cover any other type of determination or calculation with defined input/output variables.

### CROSS-REFERENCE TO RELATED APPLICATIONS

The application claims priority to U.S. Provisional Application No. 63/611,555 (Attorney Docket No. 055089.0000122), filed Dec. 18, 2023, the contents of which are incorporated by reference herein in their entirety.

### FIELD OF THE INVENTION

The present invention relates to systems and methods for implementing a tax calculation engine and more specifically to a global withholding tax engine that dynamically adjusts input attributes and parameters.

### BACKGROUND

Withholding taxes have become an area of focus at global organizations. Governments across the world are increasingly looking at withholding as a way to secure tax collections and advance revenues. This is especially notable in regions such as Latin America and Asia, where a single transaction can trigger several different withholding taxes, and in the United States where the IRS has increased its focus on withholding taxes.

While withholding tax often applies only to a small subset of payments made by an organization, failure to fully understand and comply with the applicable regulations leads to substantial liabilities, tax authority inquiries and potentially massive penalties.

With this increased scrutiny, tax departments are finding it difficult to ensure global compliance. The regulatory environment is complex and diverse—with withholding taxes applicable at different government levels—but also in constant change, forcing companies to secure resources that are closer to local regulators and can monitor updates.

Many clients are being pushed to move their Enterprise Resource Planning (ERP) systems to the cloud, and as part of this implementation, are looking to improve their withholding tax solutions. Accounts Payable and Receivable payments traditional ERP systems providers have not yet been able to provide a solution that streamlines withholding tax calculations and ongoing reporting obligations at a global scale. Currently, companies are left to build a custom solution, but this is costly and difficult to maintain.

It would be desirable, therefore, to have a system and method that could overcome the foregoing disadvantages of known systems.

### SUMMARY

According to an embodiment, the invention relates to a computer-implemented system that implements a Global Withholding Tax Engine. The system comprises: an input configured to receive one or more inputs from one or more user devices; an interactive user interface that communicates with the one or more user devices via a communication network; a storage mechanism that stores and manages withholding tax guidelines for multiple global jurisdictions; and an engine comprising a computer processor coupled to the input, the interactive user interface and the storage mechanism, the computer processor further configured to perform the steps of: receiving, via the input, one or more payment instructions with one or more withholding tax data elements wherein the one or more withholding tax data elements comprise one or more jurisdictions; dynamically adjusting a set of required data elements based on an input attribute relating to the one or more jurisdictions, wherein the input attribute is retrieved from the one or more payment instructions; determining, via a global withholding tax processor, whether the set of required data elements specific to a region has been received; based on the set of required data elements, generating, via the global withholding tax processor, a withholding tax rate and type that is in compliance with the one or more jurisdictions; automatically applying, via the global withholding tax processor, the withholding tax rate and type to the one or more payment instructions; determining, via a liability processor, a risk assessment for the withholding tax rate and type wherein the risk assessment is generated using an adaptive risk model based on tagged historical data associated with a specific region; and transmitting, via the communication network, the risk assessment to a receiving entity and wherein the risk assessment is used to continuously train the adaptive risk model.

According to another embodiment, the invention relates to a computer-implemented method that implements a Global Withholding Tax Engine. The method comprises the steps of: receiving, via an input, one or more payment instructions with one or more withholding tax data elements wherein the one or more withholding tax data elements comprise one or more jurisdictions and wherein an input configured to receive one or more inputs from one or more client devices; dynamically adjusting a set of required data elements based on an input attribute relating to the one or more jurisdictions, wherein the input attribute is retrieved from the one or more payment instructions; determining, via a global withholding tax processor, whether the set of required data elements specific to a region has been received; based on the set of required data elements, generating, via the global withholding tax processor, a withholding tax rate and type that is in compliance with the one or more jurisdictions; automatically applying, via the global withholding tax processor, the withholding tax rate and type to the one or more payment instructions; determining, via a liability processor, a risk assessment for the withholding tax rate and type wherein the risk assessment is generated using an adaptive risk model based on tagged historical data associated with a specific region; and transmitting, via a communication network, the risk assessment to a receiving entity and wherein the risk assessment is used to continuously train the adaptive risk model.

According to another embodiment, the invention also relates to a computer-readable medium containing program instructions for executing a method for implementing a Global Withholding Tax Engine.

An embodiment of the present invention is directed to an automated Global Withholding Tax Engine that leverages standardized withholding tax rules and requirements across multiple diverse jurisdictions (e.g., upwards of eighty-four jurisdictions). The Global Withholding Tax Engine addresses a technical need for tax automation in the global marketplace with dynamic adjustment of parameters and intelligent risk determinations.

The Global Withholding Tax Engine may support various implementations and environments. For example, the Global Withholding Tax Engine may be developed as a standalone engine that is system agnostic. In addition, it may offer APIs that receive as input data elements relevant to determine an applicable withholding rate. Because it utilizes a standard API, the innovative engine may be connected to any system, whether it is an ERP or other payment system. This approach allows the flexibility to meet the needs of any client, and further expand the innovative engine to address any other type of determination or calculation with defined input/output variables that may be dynamically adjusted.

The Global Withholding Tax Engine may be offered as an application that is packaged and delivered to clients to install on their own environments. The engine may be incorporated within a Digital Gateway and made available as a subscription service allowing clients to query the engine remotely and enter a withholding rate into the ERP system. In addition, the engine may also be integrated with a client's own system or ERP. Other implementations may be supported.

These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is an exemplary system diagram, according to an embodiment of the present invention.

FIG. 2 is an exemplary flow diagram, according to an embodiment of the present invention.

FIG. 3 illustrate an exemplary user interface, according to an embodiment of the present invention.

FIG. 4 illustrate an exemplary user interface, according to an embodiment of the present invention.

FIG. 5 illustrate an exemplary user interface, according to an embodiment of the present invention.

FIG. 6 illustrate an exemplary user interface, according to an embodiment of the present invention.

FIG. 7 illustrate an exemplary user interface, according to an embodiment of the present invention.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

An embodiment of the present invention is directed to a Global Withholding Tax Engine that calculates the applicable withholding tax rate based on a set of parameters of a given transaction. The Global Withholding Tax Engine may be built on a flexible model that allows updates in real-time, without the need for development resources.

For example, the Global Withholding Tax Engine may calculate the rate of withholding based on country-specific rules in conjunction with exemption certificate validation results. The Global Withholding Tax Engine may systemically calculate the applicable rate of withholding for a given payment in any jurisdiction.

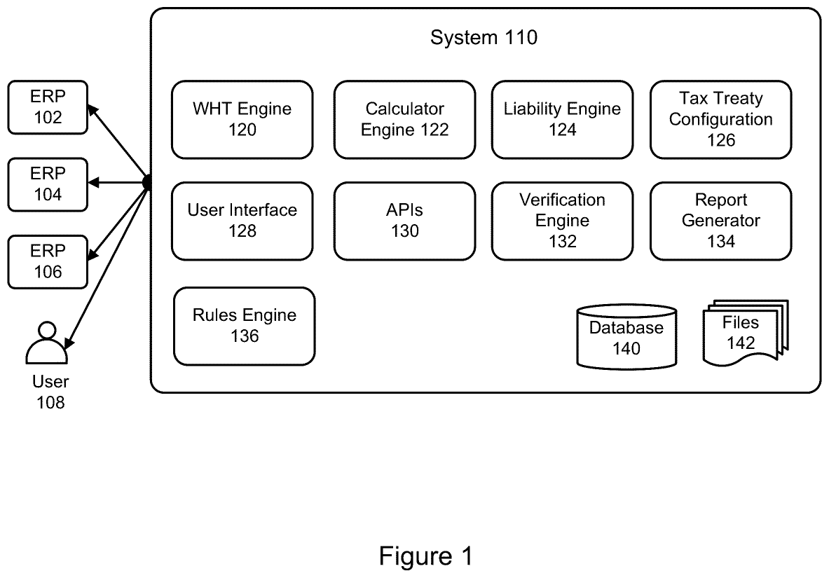

FIG. 1 is an exemplary system diagram, according to an embodiment of the present invention. System 110 may interact with various client users, as shown by User 108, including ERP systems, shown by 102, 104 106. For example, System 110 may integrate with various providers, including payment systems, financial services providers, etc.

System 110 may include various modules and functions including, but not limited to, Withholding Tax (WHT) Engine 120, Calculator Engine 122, Liability Engine 124, Tax Treaty Configuration 126, User Interface 128, APIs 130, Verification Engine 132, Report Generator 134 and Rules Engine 136. The system may store, manage and access data from various internal and/or external sources including Database 140, Files 142, etc.

WHT Engine 120 may be exposed with APIs 130 and/or integrated with ERP systems, shown by 102, 104, 106. WHT Engine 120 may include a processor or other computer/processing component that analyzes tax data and automatically calculates withholding taxes and/or tax rates for transactions, including LIVE transactions.

WHT Engine 120 may collaborate with Calculator Engine 122 and Liability Engine 124. An embodiment of the present invention is directed to applying a feature set of dynamic adjustments of input attributes per country.

WHT Engine 120 may receive attributes of a transaction as inputs and then generate an applicable WHT rate. WHT Engine 120 may dynamically change the input attributes required based on the various requirements of the country. For some countries, only 2-3 data elements are required, in others, it may be 10-12. An embodiment of the present invention may also vary the attributes based on the inputs themselves. For example, if a Payment Type is Services, then additional information, such as location of services, may be required. In addition, tax rules may be updated and shared via a file, such as an XML file, or other type of communication. This allows for faster immediate updates as tax rules changes where no development resources are required.

WHT Engine 120 may collaborate with Calculator Engine 122 that receives inputs such as tax status and annual payouts and then generates the expected payout minus federal and state withholding. Calculator Engine 122 may dynamically change the input attributes required based on various input criteria and may further adjust on a state-by-state (or other geographic/location) basis. In addition, relevant rules may be changed or updated automatically to account for new or updated rules that may be introduced every year or so as tax brackets change.

WHT Engine 120 may collaborate with Liability Engine 124 that receives a transaction history (such as amount paid, amount withheld, country details, etc.) as input, makes risk determinations and identifies areas with potential for WHT risk. This may be based on direct calculations. In addition, an embodiment of the present invention may train data over time where the data is tagged with areas where the tax authority in a local country has raised issues in the past. The tagged data may be analyzed and used to directly identify risk areas as well as used to extrapolate and/or predict potential risk. Further, Liability Engine 124 may review payments received by customers and identify areas where customers are withholding too much tax and in response provide recommendations and insights.

APIs 130 may receive multiple parameters to calculate WHT and return a response with the required data. According to an embodiment of the present invention, a WHT application may be used to onboard Customers. In addition, the WHT application may be configured for multiple countries based on Tax Treaty as well as other requirements, guidelines, etc., as shown by 126.

According to an embodiment of the present invention, transaction data will not be stored in the WHT Web application. In this example, each interaction will start a new process or workflow.

Through a User interface 128, User 108 may onboard Customers and Configure WHT Taxes. Other customizations may be implemented.

An embodiment of the present invention may capture relevant information for Transactions in the form of Logs. This may be used to validate and/or confirm Tax calculations.

An embodiment of the present invention may provide a verify/test option in the Web Application for tax calculations. Verification Engine 132 may perform checks and confirmations against a set of standards, guidelines and/or preferences. Various reports and/or other outputs may be generated as shown by Report Generator 134. For example, outputs may be automatically transmitted to a receiving system or interface.

WHT Engine 120 may be implemented in various environments, architectures, etc. For example, WHT Engine 120 may be cloud supported.

According to an embodiment of the present invention, WHT Engine 120 may further include or interact with a Rules Engine 136. Rules Engine 136 may provide a mechanism that stores rules separate from the core logic of the system, thus ensuring that any change in rules do not affect the core system. For example, input, output and rules may be in JSON format. Other formats may be supported. In addition, each country may include a rules.json file. These files may be stored in a database and associated with country or jurisdictional details. Based on an API input, WHT Engine 120 may identify a respective country rules.json file and execute against input data and then generate and transmit Withholding Tax information.

According to an embodiment of the present invention, Rules Engine 136 does not require re-compilation of an application for frequent changes of Tax Treaty between countries, as shown by 126. An embodiment of the present invention may handover the updated rules.json file to the customer where they may import into Rules Engine 136. Various encryption and security measures may be applied to a rules.json file.

An embodiment of the present invention simplifies maintenance and updates through Rules Engine 136. Updates may include regulatory changes, new regimes, etc. In addition, an embodiment of the present invention may support other forms of payment, including cryptocurrency.

Database 140 may include a SQL server, Postgres Database that represents an open-source object-relational database system. Other databases, storage devices and formats, as shown by Files 142, may be implemented.

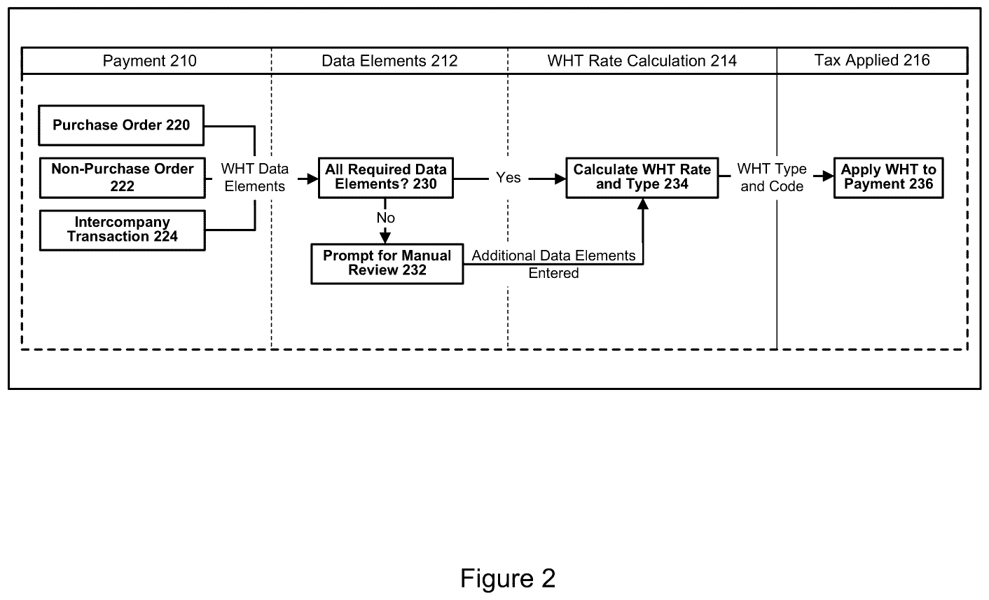

FIG. 2 is an exemplary flow diagram, according to an embodiment of the present invention. An embodiment of the present invention is directed to an automated decision engine that calculates an applicable rate based on various attributes associated with the payee and the payment.

When processing an invoice/payment, an embodiment of the present invention may automatically call an API with a set of information regarding the payee (e.g., country of residence, individual vs. entity, etc.) and the payment (e.g., type of payment such as royalties, professional services, or rents, location of services, etc.).

The decision engine, which may be part of a Global WHT Engine, may determine whether information to calculate a rate is present. If not, the user may be prompted to provide the information manually (e.g., has the supplier noted that they are subject to the alternative tax regime?). In addition, the decision engine may automatically retrieve the information from another source. The decision engine may return the correct WHT rate and type to apply to the payment.

FIG. 2 illustrates steps/phases relating to Payment 210, Data Elements 212, WHT Rate Calculation 214, and Tax Applied 216. At Payment 210, a payment type and payment details may be identified. Payment type may include: Purchase Order 220, Non-Purchase Order 222 and Intercompany Transaction 224. Other payment types and data structures may be supported. At Data Elements 212, an embodiment of the present invention may determine whether all required data elements have been received at 230. If not, a prompt for a review may be presented at 232. Upon receiving the required data elements, an embodiment of the present invention may calculate WHT rate and type at 234. The WHT rate may be applied to the payment, at 236.

Payment Information may include: Paying entity country; Type of Payment—Intercompany vs. 3^{rd} Party; Character of payment (e.g., royalties, rents, services, professional services, consulting); Set based on payment type mapping with material group and/or UNSPSC code; Character-specific attributes (e.g., Location of services; Country(ies) where IP is being used) and Threshold. Other payment information may be considered.

Payee Information may include: Payee Country; Entity Type (e.g., corporation, partnership, individual, etc.); Exemption and/or whether documentation (e.g., DTT documentation) is on file. Other payee information may be considered.

A first example may include a scenario where a Belgium Client pays an Argentina Client $50,000. Required data elements may include: for payment; payment entity country=Belgium; type of payment=intercompany. Intercompany payments are not subject to WHT in Belgium. An embodiment of the present invention may determine that no further information is required. WHT Type and Code may be represented as: 0% withholding, intercompany payment.

A second example may include a scenario where a Belgium client pays a France Consulting Entity $50,000. Required data elements may include: for payment; payment entity country=Belgium; type of payment=third party; character=consulting services; for payee, payee country =France. The payment is exempt from withholding under the Belgium-France tax treaty. An embodiment of the present invention may determine that the payee is not required to provide any documentation under Belgium law. WHT Type and Code may be represented as: 0% withholding, Treaty Exempt.

A third example may include a scenario where a Belgium client pays Argentina Consulting Entity $50,000. Required data elements may include: for payment; payment entity country=Belgium; type of payment=third party; character=consulting services; for payee, payee country=Argentina. An embodiment of the present invention may determine that under Belgium-Argentina tax treaty, consulting services are taxed at 33% of 50% of the gross payment. WHT Type and Code may be represented as: 33% withholding on 50% of the gross payment.

A fourth example may include a scenario where a Singapore client pays Malaysia Consulting Entity $50,000. Required data elements may include: for payment; payment entity country=Singapore; type of payment=third party; character=consulting services; for payee, payee country=Argentina; location of services. Client user is prompted the services were performed in Singapore and the user answers “yes.” WHT Type and Code may be represented as: 1% withholding.

An embodiment of the present invention may be applied to various applications, industries, use cases, scenarios, etc. For example, an embodiment of the present invention may be directed to a Pension and Annuity Payment Calculator.

As recognized by an embodiment of the present invention, the IRS has revamped Forms W-4P and W-4R where recipients are completing worksheets or choosing their percentage of withholding to identify amounts to be withheld from periodic or non periodic pension or annuity payments. States have various requirements to calculate withholding that do not align to the federal Forms W-4P or W-4R.

An embodiment of the present invention recognizes that recipients of periodic and non-periodic pension and annuity payments are seeking guidance in estimating federal and state withholding tax and completing Federal Forms W-4P and W-4R as well as the state equivalent forms.

Federal Form W-4P, Withholding Certificate for Periodic Pension or Annuity Payments, and the respective state equivalents are used by payers to determine the amount of federal and state income taxes to withhold and remit from a recipient's pension, annuity, profit-sharing, stock bonus plan, eligible rollover and individual retirement arrangement (IRA) payment.

As the complexity of withholding related to Federal Forms W-4P and W-4R, Withholding Certificate for Nonperiodic Payments and Eligible Rollover Distribution, and the respective state equivalents have increased because of changes in federal forms and continuously evolving state rules across the United States, periodic and non-periodic payment recipients are becoming more reliant on payors for how to complete the federal Forms W-4P and W-4R and state equivalents, and how any changes to an already completed Form W-4P and W-4R and state equivalents will impact withholding. An embodiment of the present invention is directed to a W-4P and W-4R Calculator Engine that provides payors with a technical solution and platform to give those with access to the ability to understand the amount of tax to be withheld from these payments based upon how they complete the federal and state equivalents to Forms W-4P and W-4, all in one place.

Given the various rules and requirements across the jurisdictions, information and tools necessary to calculate the withholding are currently decentralized and difficult for both payors and recipients to standardize or apply to determining withholding amounts.

When a payor provides its recipients with access to the Calculator Engine, those with access may identify how each line item on the Forms W-4P, W-4R, and state equivalents will impact the amount of tax to be withheld from applicable payments.

Those with access may enter the following information: estimated periodic or non-periodic payment amount; number of payments during the calendar year; marital status (e.g., single, married filed separate, married filing joint, surviving spouse, head of household); and information related to the recipient's tax status, including total taxable income, claims for dependents, tax credits, and applying either the standard personal income tax deduction or a different amount.

Through the user input, the Calculator Engine may reference the income tax withholding tables applicable to periodic payments of pensions and annuities for that calendar year.

In turn, the payment recipient may identify how to properly complete Form W-4P or W-4R to achieve their tax goals prior to submitting one to a payor, potentially reducing the number of questions that a payor receives from payment recipients regarding the Form W-4P or W-4R and federal/state withholding through the year and after Forms 1099-R are provided to recipients for the tax year.

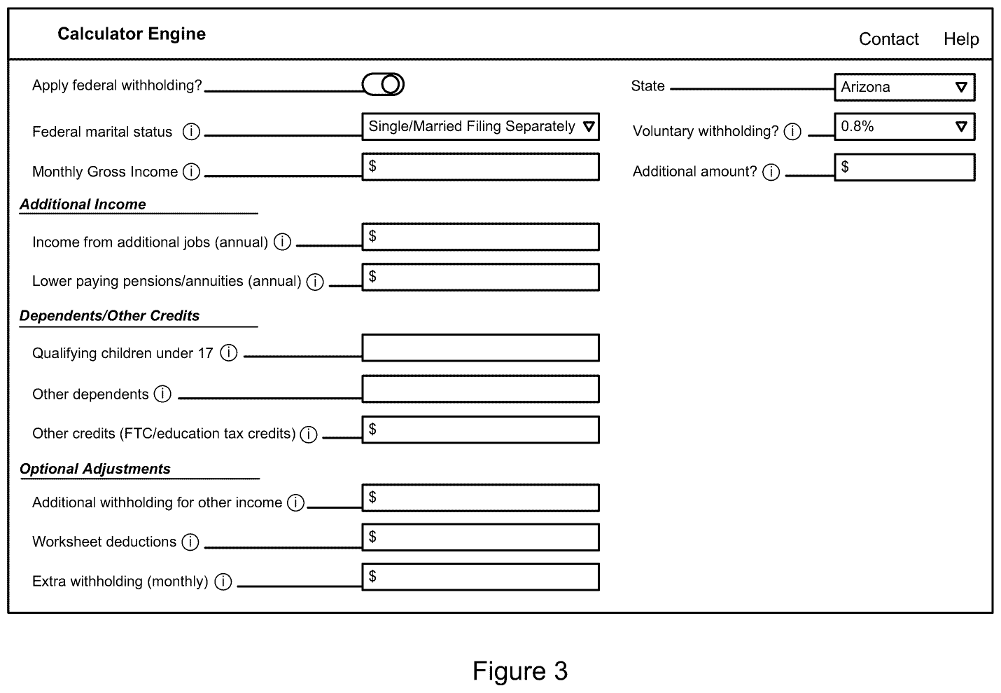

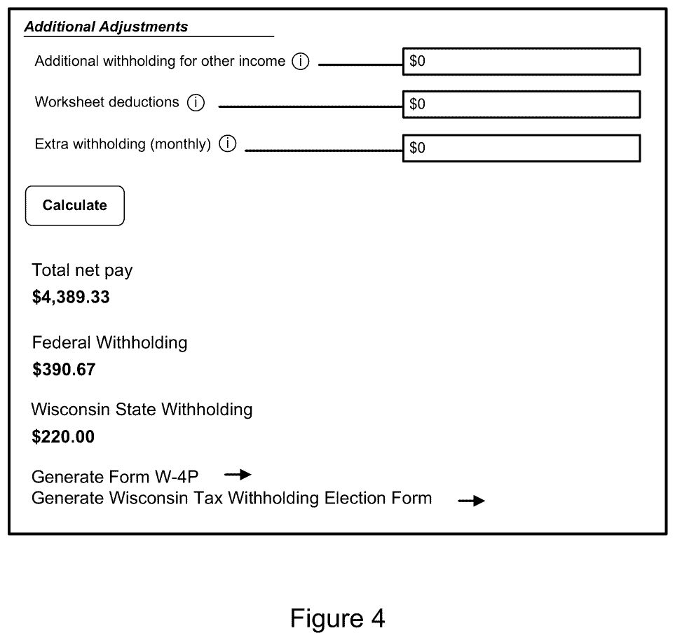

FIGS. 3 and 4 illustrate exemplary user interfaces, according to an embodiment of the present invention.

The user interface may lead the user through the required information to make withholding elections. Each field may include help text and customized guidance to explain the information required and provide helpful links to outside resources.

Based on the user inputs, an embodiment of the present invention may calculate the net pay, any potential withholding, and provide links to the relevant federal or state forms to make withholding elections.

An embodiment of the present invention is not limited to a particular application, it may be applied to other use cases and environments. For example, an embodiment of the present invention may be implemented as various calculations tools including Compliance Tool, Modeling Tool, Pricing Tool, etc. For example, an embodiment of the present invention may provide calculations, adjustments and/or recommendations to achieve a tax goal or other business goal. An international entity with multiple lines of business in various countries may use an embodiment of the present invention to strategically determine a business plan including which jurisdictions to do business in, an optimal/preferred tax rate, an amount of investment, etc. An embodiment of the present invention may also consider risk assessment, amount of potential penalties, etc.

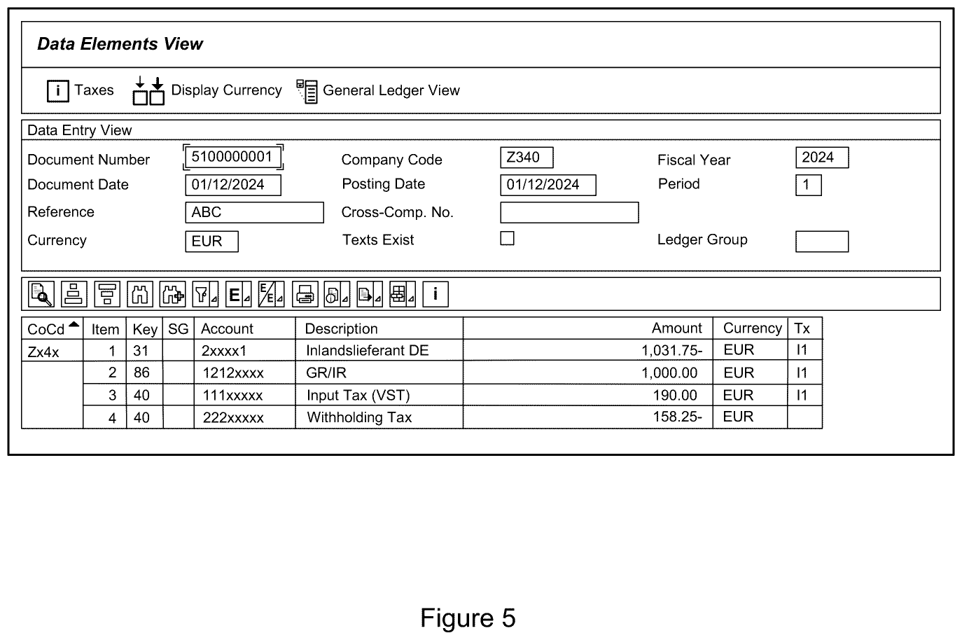

FIG. 5 illustrate an exemplary user interface, according to an embodiment of the present invention. The Global WHT Engine may connect to a payment system through an API. When an invoice or payment is processed, the ERP system may make a call to the API with the applicable transaction details. If a data point that is required to calculate the withholding tax rate is not present in the ERP system, then the user may be prompted to enter the value manually. In addition, the required data may be automatically accessed or retrieved from a source, database, external system, etc. The Global WHT Engine may then return the withholding tax type and code that applies to the invoice/payment. The withholding tax type and code match the configuration already present in the ERP system, and the ERP may apply it to the invoice/payment.

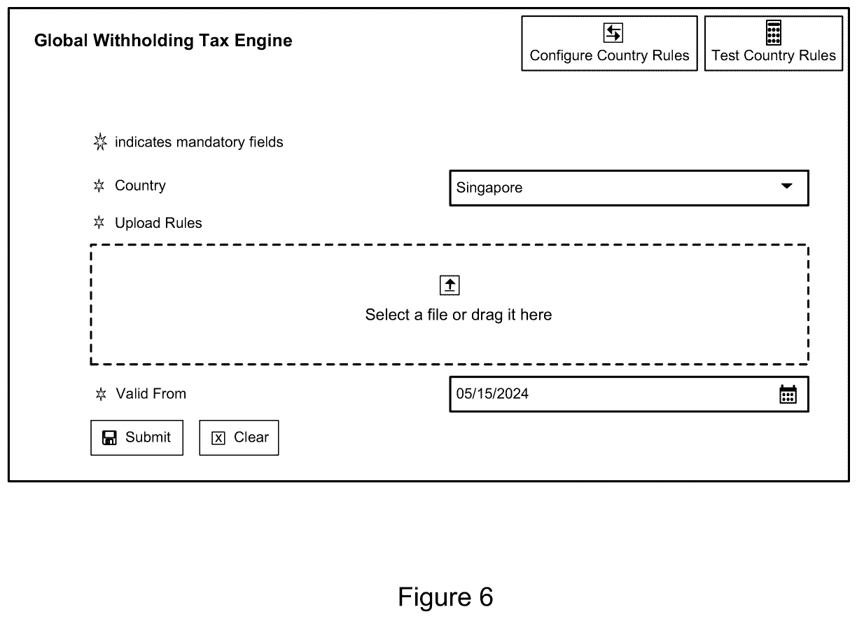

FIG. 6 illustrate an exemplary user interface, according to an embodiment of the present invention. Country rules may be dynamically updated. As withholding tax regulations and treaties change globally, an embodiment of the present invention may provide periodic updates with the latest rules.

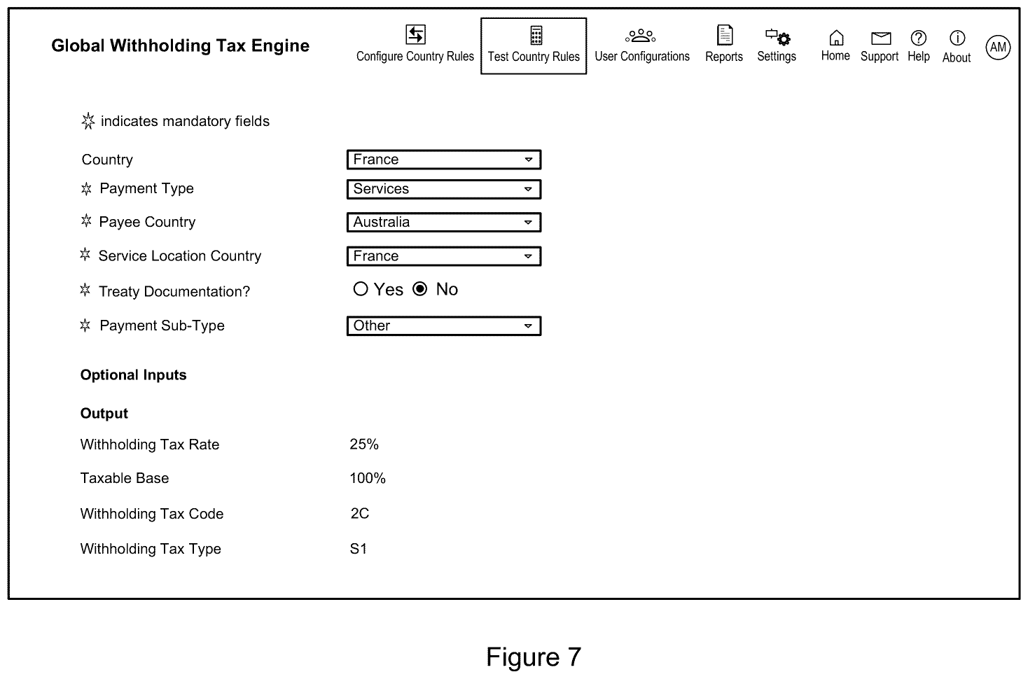

FIG. 7 illustrate an exemplary user interface, according to an embodiment of the present invention. Users may interact with an embodiment of the present invention and test applicable rates.

It will be appreciated by those persons skilled in the art that the various embodiments described herein are capable of broad utility and application. Accordingly, while the various embodiments are described herein in detail in relation to the exemplary embodiments, it is to be understood that this disclosure is illustrative and exemplary of the various embodiments and is made to provide an enabling disclosure. Accordingly, the disclosure is not intended to be construed to limit the embodiments or otherwise to exclude any other such embodiments, adaptations, variations, modifications and equivalent arrangements.

The foregoing descriptions provide examples of different configurations and features of embodiments of the invention. While certain nomenclature and types of applications/hardware are described, other names and application/hardware usage is possible and the nomenclature is provided by way of non-limiting examples only. Further, while particular embodiments are described, it should be appreciated that the features and functions of each embodiment may be combined in any combination as is within the capability of one skilled in the art. The figures provide additional exemplary details regarding the various embodiments.

Various exemplary methods are provided by way of example herein. The methods described can be executed or otherwise performed by one or a combination of various systems and modules.

The use of the term computer system in the present disclosure can relate to a single computer or multiple computers. In various embodiments, the multiple computers can be networked. The networking can be any type of network, including, but not limited to, wired and wireless networks, a local-area network, a wide-area network, and the Internet.

According to exemplary embodiments, the system software may be implemented as one or more computer program products, for example, one or more modules of computer program instructions encoded on a computer-readable medium for execution by, or to control the operation of, data processing apparatus. The implementations can include single or distributed processing of algorithms. The computer-readable medium can be a machine-readable storage device, a machine-readable storage substrate, a memory device, or a combination of one or more of them. The term “processor” encompasses all apparatus, devices, and machines for processing data, including by way of example a programmable processor, a computer, or multiple processors or computers. The apparatus can include, in addition to hardware, software code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communications network.

A computer may encompass all apparatus, devices, and machines for processing data, including by way of example a programmable processor, a computer, or multiple processors or computers. It can include, in addition to hardware, code that creates an execution environment for the computer program in question, e.g., code that constitutes processor firmware, a protocol stack, a database management system, an operating system, or a combination of one or more of them.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computer-readable media suitable for storing computer program instructions and data can include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While the embodiments have been particularly shown and described within the framework for conducting analysis, it will be appreciated that variations and modifications may be affected by a person skilled in the art without departing from the scope of the various embodiments. Furthermore, one skilled in the art will recognize that such processes and systems do not need to be restricted to the specific embodiments described herein. Other embodiments, combinations of the present embodiments, and uses and advantages of the will be apparent to those skilled in the art from consideration of the specification and practice of the embodiments disclosed herein. The specification and examples should be considered exemplary.

1. A computer-implemented system that implements a Global Withholding Tax Engine, wherein the computer-implemented system comprises:
an input configured to receive one or more inputs from one or more user devices;
an interactive user interface that communicates with the one or more user devices via a communication network;
a storage mechanism that stores and manages withholding tax guidelines for multiple global jurisdictions; and
an engine comprising a computer processor coupled to the input, the interactive user interface and the storage mechanism, the computer processor further configured to perform the steps of:
receiving, via the input, one or more payment instructions with one or more withholding tax data elements wherein the one or more withholding tax data elements comprise one or more jurisdictions;
dynamically adjusting a set of required data elements based on an input attribute relating to the one or more jurisdictions, wherein the input attribute is retrieved from the one or more payment instructions;
determining, via a global withholding tax processor, whether the set of required data elements specific to a region has been received;
based on the set of required data elements, generating, via the global withholding tax processor, a withholding tax rate and type that is in compliance with the one or more jurisdictions;
automatically applying, via the global withholding tax processor, the withholding tax rate and type to the one or more payment instructions;
determining, via a liability processor, a risk assessment for the withholding tax rate and type wherein the risk assessment is generated using an adaptive risk model based on tagged historical data associated with a specific region; and
transmitting, via the communication network, the risk assessment to a receiving entity and wherein the risk assessment is used to continuously train the adaptive risk model.

2. The computer-implemented system of claim 1, wherein the input is communicatively coupled to a remote enterprise resource planning system.

3. The computer-implemented system of claim 1, wherein the one or more withholding tax data elements relate to a purchase order.

4. The computer-implemented system of claim 1, wherein the one or more withholding tax data elements relate to an intercompany transaction.

5. The computer-implemented system of claim 1, wherein the input attribute comprises payment type.

6. The computer-implemented system of claim 1, wherein the one or more jurisdictions comprise one or more countries.

7. The computer-implemented system of claim 1, wherein the computer processor is further configured to perform the steps of: retrieving, via the input, a tax status and annual payouts; and generating, via a calculator processor, an expected payout minus federal and state withholdings.

8. The computer-implemented system of claim 1, wherein the global withholding tax processor is communicatively coupled to a rules engine that stores and manages one or more tax rule changes.

9. The computer-implemented system of claim 1, wherein the risk assessment is based on transaction history comprising amount paid, amount withheld and one or more country details.

10. The computer-implemented system of claim 1, wherein when the set of required data elements specific to the region is not received, automatically identifying at least one missing data element and making an adjustment to retrieve the at least one missing data element in response.

11. A computer-implemented method that implements a Global Withholding Tax Engine, wherein the computer-implemented method comprises the steps of:
receiving, via an input, one or more payment instructions with one or more withholding tax data elements wherein the one or more withholding tax data elements comprise one or more jurisdictions and wherein an input configured to receive one or more inputs from one or more client devices;
dynamically adjusting a set of required data elements based on an input attribute relating to the one or more jurisdictions, wherein the input attribute is retrieved from the one or more payment instructions;
determining, via a global withholding tax processor, whether the set of required data elements specific to a region has been received;
based on the set of required data elements, generating, via the global withholding tax processor, a withholding tax rate and type that is in compliance with the one or more jurisdictions;
automatically applying, via the global withholding tax processor, the withholding tax rate and type to the one or more payment instructions;
determining, via a liability processor, a risk assessment for the withholding tax rate and type wherein the risk assessment is generated using an adaptive risk model based on tagged historical data associated with a specific region; and
transmitting, via a communication network, the risk assessment to a receiving entity and wherein the risk assessment is used to continuously train the adaptive risk model.

12. The computer-implemented method of claim 11, wherein the input is communicatively coupled to a remote enterprise resource planning system.

13. The computer-implemented method of claim 11, wherein the one or more withholding tax data elements relate to a purchase order.

14. The computer-implemented method of claim 11, wherein the one or more withholding tax data elements relate to an intercompany transaction.

15. The computer-implemented method of claim 11, wherein the input attribute comprises payment type.

16. The computer-implemented method of claim 11, wherein the one or more jurisdictions comprise one or more countries.

17. The computer-implemented method of claim 11, further comprising the steps of: retrieving, via the input, a tax status and annual payouts; and generating, via a calculator processor, an expected payout minus federal and state withholdings.

18. The computer-implemented method of claim 11, wherein the global withholding tax processor is communicatively coupled to a rules engine that stores and manages one or more tax rule changes.

19. The computer-implemented method of claim 11, wherein the risk assessment is based on transaction history comprising amount paid, amount withheld and one or more country details.

20. The computer-implemented method of claim 11, wherein when the set of required data elements specific to the region is not received, automatically identifying at least one missing data element and making an adjustment to retrieve the at least one missing data element in response.
